(19) United States
(12) Patent Application Publication
(10) Pub. No.: US 2016/0368707 A1
(43) Pub. Date: Dec. 22, 2016

(54) Waste Receptacle

(71) Applicant: Joseph Joseph Limited, London (GB)

(72) Inventors: Benjamin King, London (GB); Simon Langham, London (GB); Antony Joseph, London (GB); Richard Joseph, London (GB); Gareth McNeil, London (GB)

(21) Appl. No.: 15/185,233

(22) Filed: Jun. 17, 2016

(30) Foreign Application Priority Data
Jun. 19, 2015 (GB) 1510773.3

(51) Int. Cl. B65F 1/14; B65F 1/16; B65F 1/06

(52) U.S. Cl. CPC B65F 1/1405; B65F 1/06; B65F 1/1646; B65F 1/163; B65F 2210/12

(57) ABSTRACT

This invention relates to a waste receptacle comprising a container having a means to connect a refuse bag within the container for holding waste items, and a compaction mechanism, the compaction mechanism comprising at least one compactor plate, moveable between a non-compacting position and a compacting position, wherein the at least one compactor plate is operable in use to move at least a portion of a connected refuse bag over waste items located within the refuse bag when moving from its non-compacting position to its compacting position and subsequently directly act upon an outer surface of the connected refuse bag to compact the waste items located therein.

### TECHNICAL FIELD OF THE INVENTION

The present invention relates to improvements in waste receptacles, and in particular, waste receptacles having a means to compact items located therein.

### BACKGROUND TO THE INVENTION

It is desirable to be able to compact waste, as by doing so effectively reduces or even substantially eliminates air pockets within a volume of waste ensuring that the amount of waste able to be contained within a given space is maximised. It is known in the art to provide compactors to achieve this.

Conventional compactors consist of a plate or plates which act to compact waste located within refuse bags, or in some cases loose waste, and are usually mechanically driven to exert large forces on the waste which is being compacted. Compactors of this type are generally used to compact waste on a large or even an industrial scale, in receptacles which can hold a vast quantity of waste/number of refuse bags.

However, the same issue is present on a smaller scale, such as with household bins, for example. In this situation it may be desirable to maximise the amount of waste which can be contained within a household bin, and in particular within each refuse bag. To date, however, no acceptable solution has been provided. In the absence of suitable compaction means, should a user wish to compact waste within a refuse bag he/she may be required to manually exert force on the waste by placing their hands onto the refuse bag, and in some cases directly onto the waste within the bag itself which may not be desirable. It is known in the art to provide compactors to compact individual refuse sacks however, known devices require a user to close and seal each refuse bag manually before it is compacted should he/she wish to prevent the compactor plates from coming into contact with the waste items located in the refuse bag.

It is therefore an object of aspects of the present invention to provide a waste receptacle, such as a small household bin, for example, including a compacting means which mitigates or overcomes the above-mentioned problems with the prior art.

### SUMMARY OF THE INVENTION

According to a first aspect of the present invention there is provided a waste receptacle comprising a container having a means to connect a refuse bag within the container for holding waste items and a compaction mechanism, the compaction mechanism comprising at least one compactor plate, moveable between a non-compacting position and a compacting position; wherein the at least one compactor plate is operable in use to move at least a portion of a connected refuse bag over waste items located within the refuse bag when moving from its non-compacting position to its compacting position and subsequently directly act upon an outer surface of the connected refuse bag to compact the waste items located therein.

According to a second aspect of the present invention there is provided a waste receptacle comprising a container having a refuse bag located therein for holding waste items and a compaction mechanism, the compaction mechanism comprising at least one compactor plate, moveable between a non-compacting position and a compacting position; wherein the at least one compactor plate is operable to move at least a portion of a refuse bag over waste items located within the refuse bag when moving from its non-compacting position to its compacting position and subsequently directly act upon an outer surface of the refuse bag to compact the waste items located therein.

The container may be substantially hollow and comprise a base and at least one side wall, said base and side wall(s) defining a volume within which waste items may be retained within a refuse bag connected within the container. The container may further comprise an open upper end through which said waste items may be introduced into a connected refuse bag. In this way, the container may comprise a substantially tubular configuration having a polygonal cross section. For example, the container may have a substantially spherical cross section, or may have a substantially rectangular cross section.

The open upper end of the container may comprise a width which is no greater than 16 cm, or no greater than 18 cm, or no greater than 20 cm, or no greater than 24 cm, for example. In other embodiments the open upper end of the container may comprise a width which is greater than 24 cm. In presently preferred embodiments the open upper end of the container comprises a width of 18 cm.

In embodiments wherein the container comprises a substantially spherical cross section, the width of the open upper end comprises the diameter of the spherical cross section. In alternative embodiments wherein the container comprises a rectangular cross section, the open upper end may have a width as defined above, and also a length, i.e. dimensioned in a direction which is perpendicular to the axis defining the width of the open upper end. The length of the open upper end may be no greater than 18 cm, or no greater than 25 cm, or no greater than 35 cm, or no greater than 45 cm, for example. In other embodiments the open upper end of the container may comprise a length which is greater than 45 cm.

The length and/or width of the container itself may be equal to the length/width of the open upper end as defined above. Alternatively, the length and/or width may be different to those values, and may vary along its length. Such variation may be continuous between the open upper end of the container and the base, or may be discontinuous between the open upper and of the container and the base.

The or each compactor plate may substantially flat and be of any shape or size, provided it is dimensioned to be able to fit within the volume defined by the container. The or each compactor plate may be of complementary shape to the cross-sectional shape of the container. For example, in embodiments wherein the container is substantially cylindrical, the or each compactor plate may be circular, or semi-circular, or comprise a segment of a circle. In other embodiments where the container comprises a rectangular cross section and the or each compactor plate is also substantially rectangular. Alternatively, the or each compactor plate may comprise a bar which may span at least part of the width of the container.

In some embodiments the compaction mechanism comprises more than one compactor plate. In certain embodiments the compaction mechanism consists of two compactor plates. In embodiments wherein the compaction mechanism comprises more than one compactor plate, each plate may be the same size and shape, or may have a different size and shape to at least one other compactor plate.

In some embodiments the or each compactor plate is located within the volume defined by the container when in its non-compacting position. In this way, the or each compactor plate is not visible from outside of the waste receptacle during normal use of the receptacle, i.e. filling the container with waste items and subsequent storage thereof. This solution is both aesthetically pleasing and also provides an increased level of hygiene as the compactor plate(s), which may but not necessarily contact waste items in use, are fully enclosed within the container when the compacting mechanism is not in use.

The at least one compactor plate may be rotatable between its non-compacting position and its compacting position. In such embodiments, the or each compactor plate may be located parallel and adjacent to a side wall of the container in its non-compacting position and may be rotatable to its compacting position in which it is located perpendicular to said side wall of the container. In this way, when the compacting mechanism is not in use, the compactor plate(s) are positioned such that they do not interfere with the normal operation of the waste receptacle.

Alternatively, the at least one compactor plate may be linearly moveable between its non-compacting position and its compacting position. In such embodiments, the or each compactor plate may be located perpendicular and adjacent to a side wall of the container is its non-compacting position in a position where it is not positioned directly above a refuse bag connected within the container, and may be moveable horizontally to a position in which it is located directly above the connected refuse bag remaining perpendicular to the side wall of the container. In some embodiments the or each compactor plate may be moveable both horizontally and vertically in a linear fashion between its non-compacting position and its compacting position. In such embodiments the or each compactor plate may initially move vertically and subsequently move horizontally to move up and over the waste items. Alternatively, the or each compactor plate may move diagonally, i.e. with respect to both a vertical and horizontal axis at the same time, to move up and over the waste items. The or each compactor plate may then move vertically downwards to compact said waste items.

The at least one portion of a connected refuse bag moved over the waste items under operation of the or each compactor plate may comprise a portion defining an open end of the refuse bag. In this way, the or each compactor plate acts to move said open end of the refuse bag over waste items located therein and at least partially close said open end bag when moving from its non-compacting position to its compacting position. By providing such a configuration, the or each compactor plate is operable in use to act only upon an outer surface of the connected refuse bag when used to compact said bag, rather than directly on waste items located within the refuse bag. This is particularly advantageous as it allows for the compaction of waste items located within the refuse bag whilst not coming into contact with the waste items themselves, which is desirable for hygienic purposes.

In order to act upon the or each portion of a connected refuse bag, the compaction mechanism includes a means to attach the refuse bag thereto which may be located on at least one of the or each compactor plates. The attachment means may be any form of fastener suitable for retaining a refuse bag within the waste receptacle in a desired configuration. For example, the attachment means may comprise a clip or clips. In some embodiments the attachment means may comprise a hook, or a series of hooks for engaging the portion(s) of the refuse bag, in use.

The or each compactor plate may only partially close a connected refuse bag when moving from its non-compacting position to its compacting position such that there is provided an air flow into and out of the refuse bag. In this way, the number of air pockets present within the refuse bag upon compaction may be kept to a minimum. In embodiments wherein there is provided more than one compactor plate, there may be provided at least one gap between each compactor plate when in their compacting positions to provide said air flow.

In some embodiments the compaction mechanism may be configured such that when the or each plate is in its non-compacting position, a connected refuse bag is retained in an open configuration, i.e. a configuration wherein the refuse bag is open at one end to allow for insertion of further waste items into the bag. In this way, the waste receptacle of the present invention allows for compaction of waste items and refuse bags during the filling process, rather than simply once a refuse bag has been completely filled. This ensures that the maximum amount of waste is contained within any single refuse bag.

The at least one compactor plate may be moveable between its non-compacting position and its compacting position under the operation of an actuation means.

In some embodiments the actuation means may comprise a motor, which may be an electric motor, for example. The motor may be operable to move the or each compactor plate between its non-compacting position and its compacting position upon operation of the motor by a user. In such embodiments the actuation means may be controllable by means of a control operated by a user which may be operable to control the speed and/or direction which the motor is running. For example, the motor may run in two directions, the first resulting in the movement of the or each compactor plate from its non-compacting position to its compacting position, and a second direction in which the or each compactor plate is moved from its compacting position to its non-compacting position.

In further embodiments the actuation means may comprise an operating handle which may be moveable. The operating handle may move between a first position and a second position. Upon movement of said operating handle between said positions, the or each compactor plate may move between its non-compacting position and its compacting position.

In embodiments wherein the waste receptacle comprises an actuation means in the form of an operating handle, the handle may be moveable between its first position and its second position upon the application of a force by a user. In other embodiments the operating handle is resiliently biased towards the first position and will be retained in said first position in the absence of an operating force. In such embodiments, the handle may be moved from its first position to its second position upon the application of a force by a user, and subsequently return to said first position upon removal of the applied force.

In some embodiments the operating handle may be moved from its first position to its second position through linear movement of the operating handle. In some embodiments the operating handle may be moveable from its first position to its second position through linear depression of the handle and may be returned to its first position by pulling the handle back to the first position. In embodiments wherein the operating handle is biased towards said first position the may return to the first position automatically. In some embodiments the operating handle may be moved from its first position to its second position by depressing the handle into a volume defined by the container. In other embodiments the operating handle may be moveable between its first position and its second position through rotation of the operating handle about a fixed axis.

The operating handle may be moveable between its first position and its second position via an intermediary position. In such embodiments, the operating handle may comprise a folding handle which may be rotatable between its first position and said intermediary position, and linearly moveable between the intermediary position and its second position. For example, the operating handle may be rotated (or folded) from a position wherein the handle is prevented from being depressed into the volume defined by the container to a position wherein the handle may be linearly depressed into the volume defined by the container. In this way, unwanted actuation of the compaction mechanism is prevented. In other embodiments the operating handle may comprise a telescopic handle which may be project telescopically between its first position and its intermediary position, and subsequently move linearly between its intermediary position and its second position. In this way, the handle may be retained in a position wherein it does not obstruct the normal operation of the waste receptacle, i.e. filling and storing waste items, when the compaction mechanism is not in use.

In yet further embodiments the operating handle may be lockable in its first position.

In embodiments wherein the operating handle is moveable between a first position and a second position via an intermediary position the handle may comprise a biasing means to bias the handle from any of these positions towards any other position. For example, the operating handle may be biased towards its first position from its second position through its intermediary position, or may be biased from its second position to its intermediary position only, or from its intermediary position to its first position only. Said biasing may also be applied in the opposite sense to the examples described above. In an exemplary embodiment, the operating handle is biased towards its intermediary position from its second position and is subsequently moveable from its intermediary position to its first position upon manual operation by a user.

The operating handle may comprise a means to control the motion of the operating handle between its first and second positions. For example, the operating handle may additionally comprise a pin, which may be a spring-guide pin. In such embodiments, the pin may control the distance into which the handle may be moved into the container. Additionally or alternatively, the pin may control the distance from which the handle may be moved out of the container. For example, the pin may prevent the handle being moved too far out of the container such that it is detached from the waste receptacle itself.

In some embodiments the operating handle is located directly above the open upper end of the container when in its first position. In this way, the operating handle may be moved to its second position by depressing the handle directly downwards into the container. In other embodiments, and in particular those embodiments wherein the operating handle is moved to an intermediary position before being subsequently moved to its second position, the handle may be located away from the open upper end of the container. In such embodiments, the handle may be moved from its first position to an intermediary position which is directly above the open upper end of the container and then be depressed directly downwards into the container towards its second position, in use. Such embodiments may be particularly desirable as the operating handle is located away from waste items located within the container between uses thereby improving the hygiene of the waste receptacle as a whole. The operating handle may also be configured to be sufficiently distanced from the waste items/refuse bag even during use of the compaction mechanism. For example, the operating handle may comprise one or more supporting arms which translate the operation of the operating handle to the compaction mechanism without a user's hand coming in close proximity of the compactor plates, or a connected refuse bag, or waste items located within a refuse bag when operating the handle. In this way, the operating handle is located away from waste items located within the container, or within a connected refuse bag within the container at all times thereby improving the hygiene of the waste receptacle as a whole.

In embodiments wherein the operating handle is initially moved from its first position to an intermediary position, the at least one compactor plate may be moveable between its non-compacting position to its compacting position upon movement of the operating handle from its first position to said intermediary position, or during at least a portion of the movement of the operating handle between these positions. The waste receptacle may be configured such that the or each compactor plate is retained in its compacting position whilst the operating handle is in its intermediary position, its second position, and/or during movement of the operating handle between these positions. In other embodiments, the at least one compactor plate may be moveable between its non-compacting position to its compacting position upon movement of the operating handle between the intermediary position and its second position, or during at least a portion of the movement of the operating handle between these positions.

The operating handle may additionally comprise a finger guard. The finger guard may comprise a portion of the handle acting as a barrier positioned to prevent a user's hands or fingers coming into contact with the or each compactor plate, a connected refuse bag or waste items when operating the handle.

The compaction mechanism may comprise one or more supporting arms connected to the or each compactor plate. The one or more supporting arms may connect the or each compactor plate to a pivot point about which the or each plate may rotate in use. In this way, the one or more supporting arms act to move the or each compactor plate about the pivot point in a circular motion. The length of the one or more supporting arms, and hence the radius of the circle defined by the circular motion of the or each compactor plate may be no more than 6 cm, or may be no more than 9 cm, or may be no more than 11.5 cm, or may be no more than 13 cm. In some embodiments the length of the one or more supporting arms may be more than 13 cm. In presently preferred embodiments the one or more supporting arms are 11.5 cm in length.

In embodiments wherein the compaction mechanism comprises an operating handle, the operating handle may also be connected to the pivot point and may be stationary with respect to the pivot point or may be rotatable with respect to the pivot point in embodiments wherein the operating handle is rotatable for at least part of its movement between its first position and its second position.

In some embodiments there may be provided more than one pivot point, such as two pivot points, for example. In such embodiments, the or each compactor plate is provided with at least one supporting arm for each pivot point. In some embodiments the compaction mechanism comprises two pivot points defining an axis of rotation through said points. In such embodiments, there may be provided a first supporting arm for the or each compactor plate connected to a first pivot point and a second supporting arm for the or each compactor plate connected to a second pivot point. In such embodiments, the operating handle may also be connected to both of the first and second pivot points. In this way, each of the operating handle and one or more compactor plates is rotatable about the same axis.

The container may additionally comprise one or more elongate slots along one or more side walls thereof The or each elongate slot may engage a portion or portions of the compaction mechanism in use. For example, the portion or portions of the compaction mechanism may be moved along said elongate slot(s) during movement of the or each compactor plate from its non-compacting position to its compacting position. In embodiments wherein there is provided an operating handle to actuate the movement of the or each compactor plate, the portion of portions of the compaction mechanism may be moved along said elongate slot(s) during movement of the operating handle between its first position and its second position, or between its intermediary position and its second position.

The portion or portions of the compaction mechanism which may be moved along the or each elongate slot during use may additionally comprise a wedge-shaped member, the member having a width and/or depth which tapers along the length of the member. In such embodiments, wedge-shaped member or members may be configured to act to displace any items located within the or each elongate slot as the compaction mechanism is moved therealong. In this way, the mechanism provides a means to remove any waste items which may have moved into the slot(s) and would otherwise prevent movement of the compaction mechanism along the slot(s). The or each wedge-shaped member may also provide a means to control the distance which the compaction mechanism may be moved along the or each elongate slot.

In further embodiments, for example in those wherein the compaction mechanism comprises an actuation means in the form of a motor, the portion or portions of the compaction mechanism may be moved along said elongate slot(s) under the operation of said motor. In such embodiments the portion or portions of the compaction mechanism may comprise one or more rods which are engage the or each elongate slot and move therealong.

In some embodiments, the portion or portions of the compaction mechanism received within the or each elongate slot comprises the pivot point or points. In this way, the pivot point(s) may provide both an axis of rotation for the components of the compaction mechanism and also a guiding means for operation of the mechanism.

In some embodiments the or each elongate slot is configured to urge movement of a component or components of the compaction mechanism as the or each pivot point is moved therealong. For example, the or each elongate slot may act to rotate the at least one compactor plate from its non-compacting position to its compacting position as the or each pivot point is moved along at least a section of its corresponding elongate slot. In such embodiments the or each elongate slot is configured to act upon one or more supporting arms of the compaction mechanism to cause said rotation of the at least one compactor plate. Alternatively, the or each elongate slot may act to urge linear movement of the at least one compactor plate from its non-compacting position to its compacting position as a portion or portions of the compaction mechanism are moved therealong. To effect the above detailed movement of the at least one compactor plate, the or each elongate slot may configured to comprise a tapered upper end which is wider at an open end and narrows therealong. In this way, the tapering acts to urge movement of the or each compactor plate as the portion(s) of the compaction mechanism are moved along said tapered slot(s).

Furthermore, in embodiments wherein the or each elongate slot is operable to act upon the one or more supporting arms of the compaction mechanism in use, the or each slot may be dimensioned to receive at least a portion of the one or more supporting arms. Additionally or alternatively, in embodiments wherein the actuation means comprises an operating handle, the or each slot may be dimensioned to receive at least a portion of the operating handle in use.

The above configuration provides an automated means to move the or each compactor plate into position during operation of the waste receptacle. In this way, a user does not have to come into contact with the or each compactor plate which may be a desirable feature for hygienic purposes. The container may additionally comprise a removable lid which covers the open upper end between uses of the waste receptacle. In such embodiments, the removable lid may be removed to allow access to either the container itself or the compaction mechanism. The lid may be hingedly connected to the container and may be moveable upon the operation of a foot pedal, such mechanisms being well-known in the art.

According to a third aspect of the present invention there is provided a method of compacting waste items located in a refuse bag within the waste receptacle of the first aspect of the present invention, the method comprising the steps of:

a) connecting a refuse bag within the waste receptacle;

b) moving the at least one compactor plate from its non-compacting positon to its compacting position;

c) moving at least a portion of the refuse bag over waste items located therein to at least partially close the refuse bag; and

d) moving the at least one compactor plate when in its compacting position in a direction to act upon an outer surface of the refuse bag to compact the waste items.

The portion of the refuse bag which is moved over the waste items may be moved automatically upon the movement of the at least one compactor plate from its non-compacting position to its compacting position.

In some embodiments the at least one compactor plate is moved from its non-compacting position to its compacting position, and subsequently moved to compact said waste items under the operation of an actuation means, which may be an operating handle, for example. Alternatively, the actuation means may comprise an electric motor.

In some embodiments the at least one compactor plate may be moved from its non-compacting position to its compacting position automatically as the operating handle is moved from a first position to a second position. Additionally or alternatively, the movement of the operating handle from its first position to its second position may result in the movement of the at least one compactor plate to compact the waste items.

The at least one compactor plate may be rotated from its non-compacting position to its compacting position. Alternatively, the at least one compactor plate may be moved linearly between its non-compacting position and its compacting position.

In embodiments comprising an operating handle, the at least one compactor plate may be moved from its non-compacting position to its compacting position automatically as the operating handle is moved from its first position to its intermediary position, or during at least a portion of the movement of the operating handle between these positions. In such embodiments, the at least one compactor plate may be moved to compact the waste items upon movement of the operating handle from its first position to its intermediary position, or during movement of the operating handle from its intermediary position to its second position, or during at least a portion of the movement of the operating handle between these positions. Alternatively, the at least one compactor plate may be moved from its non-compacting position to its compacting position, and may subsequently be moved to compact the waste items, automatically as the operating handle is moved from its intermediary position to its second position, or during at least a portion of the movement of the operating handle between these positions.

In some embodiments the operating handle may be rotated between its first position and its second position, or may be rotated between its first position and an intermediary position, and/or may be rotated between an intermediary position and its second position. In other embodiments the operating handle may be moved linearly between any of the aforementioned positions. In some embodiments the operating handle is rotated from its first position to an intermediary position and subsequently moved linearly between the intermediary position and its second position.

In some embodiments the method comprises the step of closing the refuse bag before the waste items located therein are compacted. In such embodiments, the refuse bag may be closed automatically as the at least one compactor plate is moved from its non-compacting position to its compacting position. In alternative embodiments the refuse sack may be closed automatically upon the operating of the actuation means, such as upon the movement of the operating handle from its first position to its second position, or from its first position to an intermediary position, or from an intermediary position to its second positon, for example.

Subsequent to compaction of the waste items, the process may be reversed to re-set the waste receptacle. For instance, the at least one compactor plate may be moved from the position wherein it is acting upon the outer surface of the refuse bag to compact the waste items to a position where it is not, the refuse bag may be re-opened by moving the portion of the refuse bag initially used to at least partially close the refuse bag, and moving the at least one compactor plate from its compacting position to its non-compacting position. The waste receptacle may be re-set automatically. Alternatively, the waste receptacle may be re-set under the operating of the actuation means by the reverse process to that described above. For example, in embodiments wherein the actuation means comprises an operating handle, the waste receptacle may be re-set by moving the operating handle from its second position to its first position, which may be via an intermediary position. The movement of the operating handle between these positions may automatically cause the at least one compactor plate to move from the position wherein it is acting upon an outer surface of the refuse bag to compact the waste items to a position where it is not, or from its compacting position to its non-compacting position, for example.

### DETAILED DESCRIPTION OF THE INVENTION

In order that the invention may be more clearly understood an embodiment thereof will now be described, by way of example only, with reference to the accompanying drawings, of which:

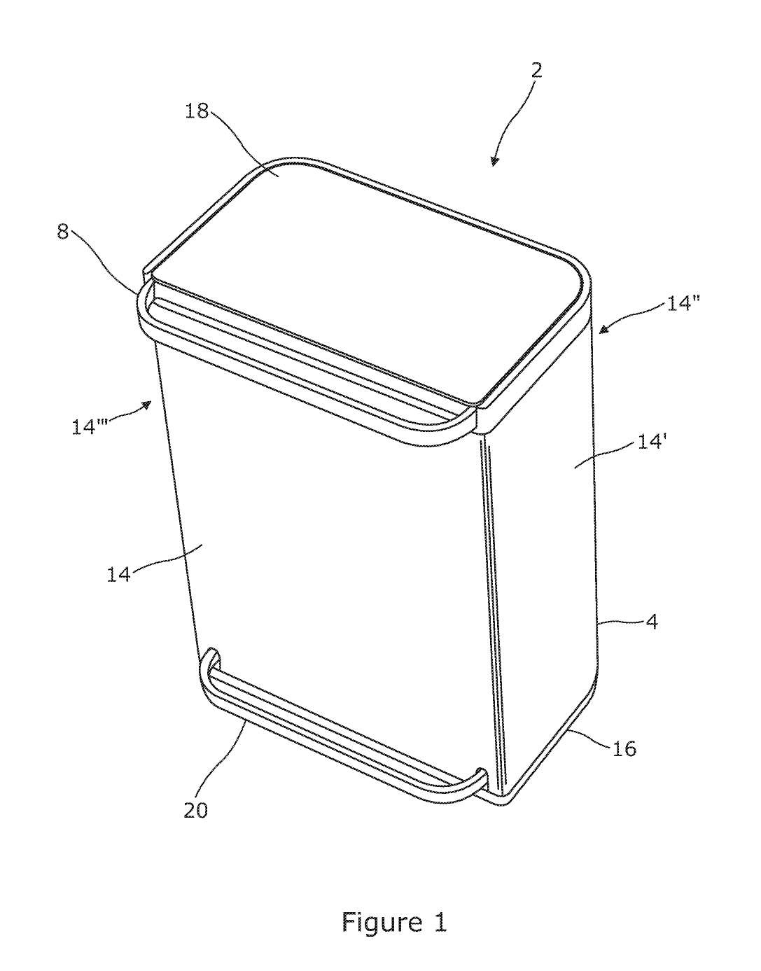

FIG. 1 is a perspective view of an embodiment of a waste receptacle of the present invention.

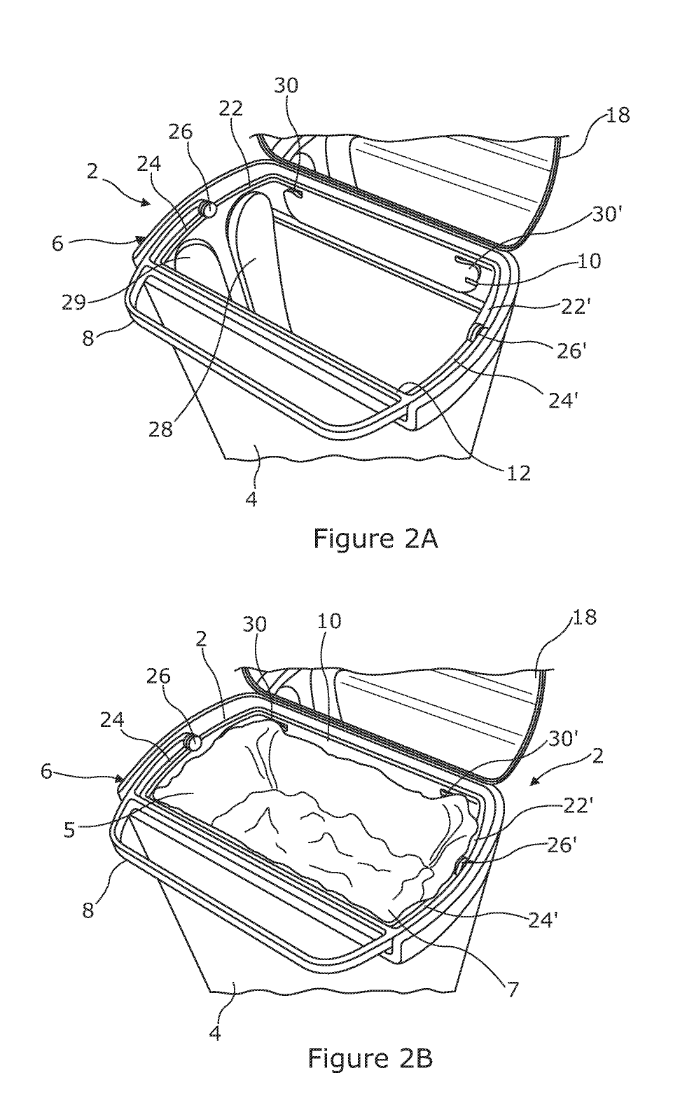

FIGS. 2A-2B are further perspective views of the waste receptacle shown in FIG. 1 illustrating the internal workings of the receptacle.

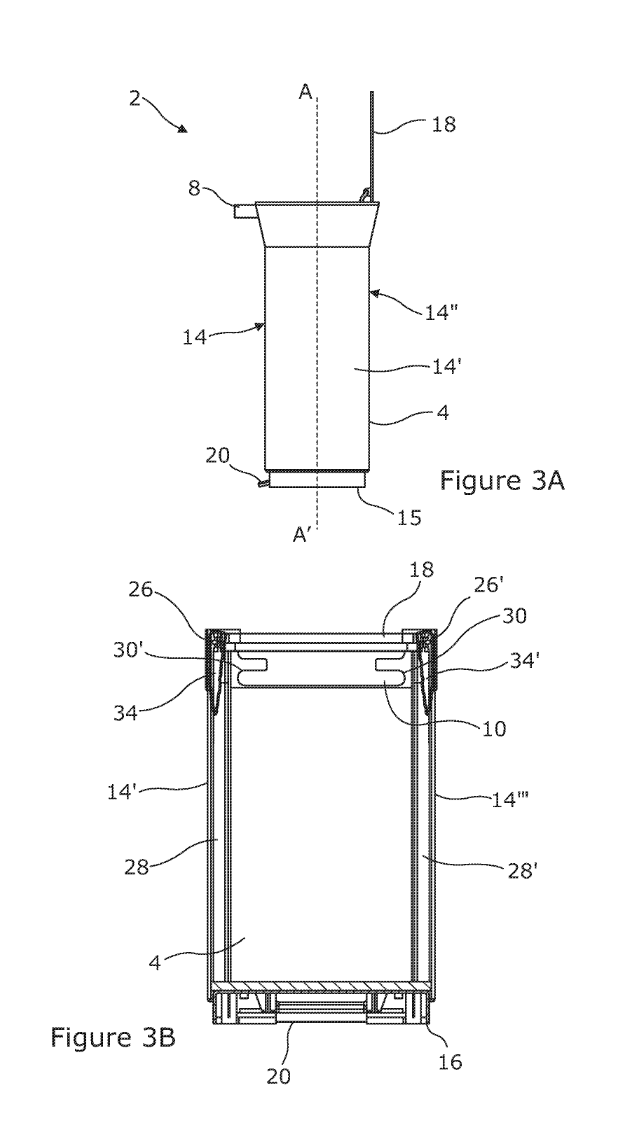

FIG. 3A is a further perspective view of the embodiment of the waste receptacle of the present invention shown in FIGS. 1 and 2.

FIG. 3B is a side cross sectional view of the waste receptacle shown in FIG. 3A through the line A-A′.

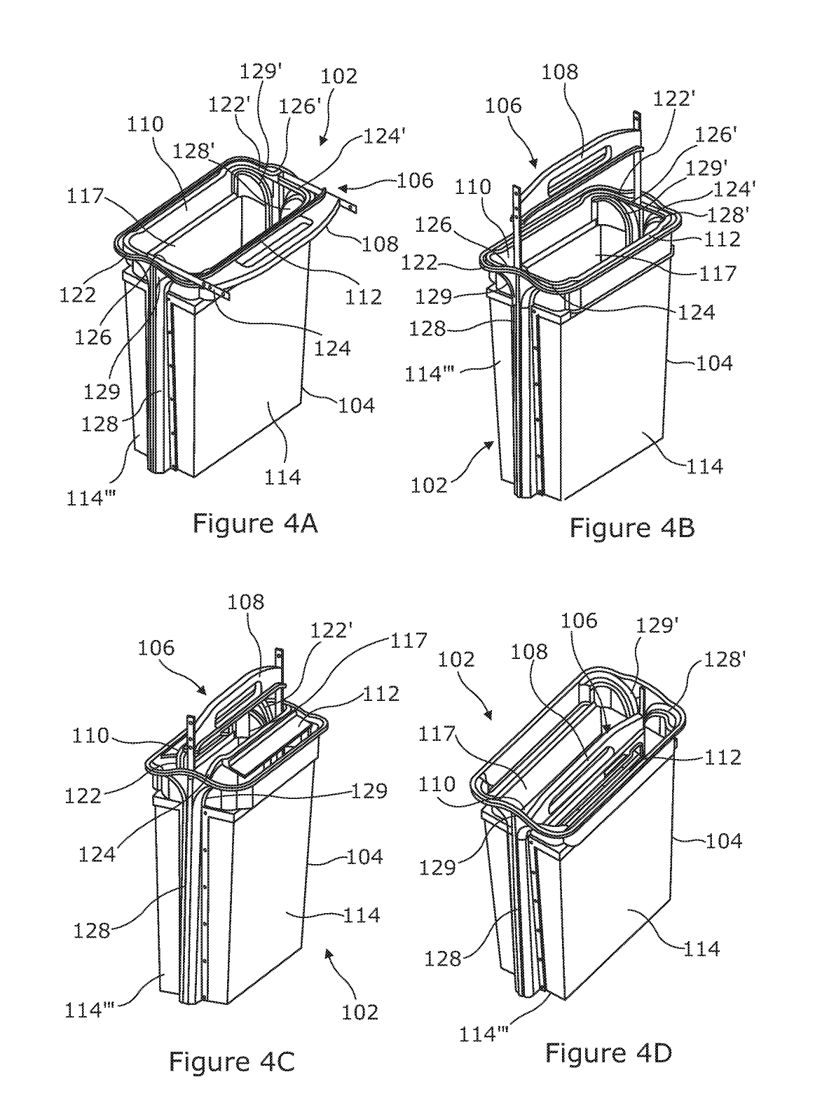

FIGS. 4A-4D are a series of perspective views demonstrating the operational use of an embodiment of a waste receptacle of the present invention.

FIGS. 1, 2A, 2B, 3A and 3B illustrate an exemplary embodiment of a waste receptacle 2 of the present invention, with FIG. 2A showing the receptacle 2 empty to illustrate the internal workings of the receptacle 2, and FIG. 2B showing the receptacle 2 in use with a refuse bag 5 located therein.

The waste receptacle 2 includes a container 4 comprising side walls 14, 14′, 14″, 14″′ forming a substantially rectangular tubular configuration having a base 16 at a first end and an opposing open upper end 17. The container 4 forms an enclosure for refuse bag 5 which will contain waste items 7, in use. The receptacle 2 also includes a compaction mechanism 6 located substantially within the volume enclosed by the container 4. In the illustrated embodiment, the receptacle 2 also includes a lid 18 which is hingedly connected to a portion on the side wall 14″ of the container 4, the lid being openable upon the application of a force to a foot pedal 20.

The compaction mechanism comprises an actuation means in the form of operating handle 8 and a pair of compactor plates 10, 12, each of which being connected to both a first pivot point 26 and a second pivot point 26′ and are rotatable about the pivot points 26, 26′.

The compactor plates 10, 12 are substantially flat and are approximately rectangular in shape. Each plate 10, 12 is connected to the first pivot point 26 by respective supporting arms 22, 24 and to the second pivot point 26′ by respective supporting arms 22′, 24′, each supporting arm 22, 24; 22′, 24′ being connected to its corresponding compactor plate 10, 12 at an opposing end to the other of the supporting arms 24, 22; 24′, 22′.

As shown in FIG. 2B, the compaction plates 10, 12 are located such that they contact and act upon an outer surface of the refuse bag 5, in use.

The compactor plates 10, 12 also include attachment means in the form of respective hooks 30, 30′ and 32, 32′ (not shown) at opposing ends thereof. The hooks 30, 30′; 32, 32′ are configured to allow for the attachment of the refuse bag 5 thereto, as shown in FIG. 2B. By providing four hooks 30, 30′; 32, 32′, when a refuse bag is attached to each hook the bag is retained in an open configuration, i.e. presenting an open end of the bag into which waste items may be located, during non-operational use of the compaction mechanism 6. The configuration and operational use of the hooks 30, 30′; 32, 32′ during operation of the compaction mechanism 6 will be described hereinafter.

The container 4 also includes a pair of elongate slots 28, 28′ located within an inner surface of opposing container side walls 14′, 14″′. The slots 28, 28′ run along substantially the entire length of the respective side walls 14′, 14″′ and are dimensioned to be able to receive opposing portions of the operating handle 8, along with corresponding pivot points 26, 26′, and portions of respective supporting arms 22, 24; 22′, 24′. Each elongate slot 28, 28′ also comprises a flared upper end 29, 29′ which is wider at its uppermost end (in the orientation shown in FIG. 2A) and tapers to the width of the remainder of its respective slot 28, 28′. The operational use of the flared upper ends 29, 29′ of the elongate slots 28, 28′ will be described hereinafter.

The compaction mechanism further comprises a pair of wedge-shaped members 34, 34′ which are connected to respective pivot points 26, 26′. The wedge-shaped members 34, 34′ are configured to be located within respective elongate slots 28, 28′ during use. As shown in FIG. 3B, each of the wedge-shaped members 34, 34′ comprises a substantially triangular cross-section, having a vertical edge adjacent to respective container wall 14′, 14″′ and a sloping edge adjacent to the interior of the container 4. The operational use of the wedge-shaped members 34, 34′ will be described hereinafter.

The operational use of a waste receptacle 102 which is similar to the waste receptacle 2 as shown in FIGS. 1, 2A, 2B, 3A and 3B will now be described with reference to FIGS. 4A-4D, which are shown without a refuse bag located within the container 104 to better illustrate the operational use of the receptacle 102. It should, however, be appreciated that receptacle 102 will include a refuse bag as shown in FIG. 2B during use. Where appropriate, like reference numerals have been used to identify equivalent components.

In its non-operational configuration, as shown in FIG. 4A, the operating handle 108 is kept in a position where it does not obstruct the open upper end 117 of the container 104, hereinafter its first position. In this way, a user of the receptacle 102 is not prevented from placing waste items within the container 104. It is envisaged that the receptacle 102 will be retained in the configuration shown in FIG. 4A during “normal use”, i.e. filling the container, or indeed a refuse bag located within the container, with waste items and the subsequent storage thereof.

In order to start the compaction process, a user moves the operating handle 108 from its first position, as shown in FIG. 4A, to the position shown in FIG. 4B, hereinafter referred to as its intermediary position. To achieve this, the operating handle is rotated about pivot points 126, 126′. In its intermediary position, the operating handle 108 is position directly above the open upper end 117 of the container 104.

From its intermediary position, the operating handle 108 may be depressed in a downwards direction as shown in FIG. 4C. To allow for this, the pivot points 126, 126′, along with opposing portions of the operating handle 108 itself, travel along corresponding elongate slots 128, 128′. At the same time, compactor plates 110, 112 are rotated from the position shown in FIGS. 4A and 4B, hereinafter referred to as their non-compacting position, in which they are located parallel and adjacent to container side walls 114, 114″, towards a position wherein each compactor plate 110, 112 is located perpendicular to the side walls 114, 114″, hereinafter referred to as their compacting positon. To achieve this, the flared upper ends 129, 129′ of respective elongate slots 28, 28 are configured to act upon respective supporting arms 122, 124; 122′, 124′ of compactor plates 110, 112, to urge the plates 110, 112 towards their compacting position as the operating handle 108 and pivot points 126, 126′ are initially moved along the slots 128, 128′. By configuring the compaction mechanism 6 in this way, a user need not contact the compactor plates 110, 112 directly in order to move the plates between their non-compacting positions and their compacting positions.

The compactor plates 110, 112 are shown in their compacting position in FIG. 4D. In this position, the plates 110, 112 form a flat surface which may act upon waste items located within the container 104, or more specifically on the outer surface of a refuse bag located within the container holding the waste items. From the position shown in FIG. 4D, the compaction mechanism 106 may be depressed further into the container 104 (in a downwards direction in the orientation shown in the Figures) in order to fully compact waste items located within the container 104 or within a refuse bag within the container 104. On the other hand, the compaction mechanism may be withdrawn from within the container 104 and returned to the configuration shown in FIG. 4A using the reverse process of the above.

Moving the operating handle 108 from the position shown in FIG. 4B to the position shown in FIG. 4D results in the wedge-shaped members (not shown in FIGS. 4A-4D) moving along their respective elongate slots 128, 128′. The configuration of the wedge-shaped members is such that upon movement between the two positions, the members act to displace any items which may be present within the slots 128, 128′ such as stray waste items, for example. In this way, the wedge-shaped members provide a means to prevent any items located within the slots 128, 128′ from preventing movement of the operating handle 108 and hence operation of the compaction mechanism itself. The wedge-shaped members also control the depth to which the operating handle 108 may be depressed into the container 104.

Although not illustrated in FIGS. 4A-4D, the compaction mechanism 106 may further include attachment means in the form of hooks at points on one or more of the compactor plates 110, 112, as in the embodiment shown in FIGS. 1, 2A, 2B and 3. In this way, the hooks on the compactor plates 110, 112 provide a means to attach a refuse bag thereto and enable the compactor plates 110, 112 to act directly on the outside of a refuse bag. To achieve this, the upper open end of a refuse bag is connected to the innermost surface of the or each compactor plate 110, 112, i.e. the underside surface of the compactor plates 110, 112 in the orientation shown in FIGS. 4C and 4D. By configuring the compactor plates 110, 112 in this way, when the compactor plates move from their non-compacting position to their compacting position, the open upper end of the refuse bag is closed, thereby allowing the compaction mechanism 106 to act on the refuse bag only.

Although the illustrated waste receptacles 2; 102 comprise only two compactor plates 10, 12; 110, 112 it should be appreciated that any number of plates may be employed, such as a single compactor plate, or three or more compactor plates, for example. Equally, the compactor plates need not be of the same size and shape as the illustrated plates. Rather, the compactor plates may be of any shape, and may, but not necessarily be complementary to the cross-sectional shape of the container 4; 104. In currently envisaged embodiments the container may comprise a substantially circular cross-section and the compactor plates may be circular also, or may be semi-circular, or may comprise a segment of a circle, for example.

In the illustrated embodiments the operating handle 8; 108 comprises a single member spanning the entire width of the receptacle 2; 102. However, the operating handle need not be limited to this configuration. Rather, the operating handle may comprise two or more members, or may be a single member which has a smaller width to the illustrated embodiments. In further embodiments the actuation means may not comprise an operating handle 8; 108 as illustrated, but rather comprises a different means to actuate the motion of the compactor plates 10, 12; 110, 112, such as an electric motor, for example, the operation of which may be controllable using an electronic switch operable by the user.

In embodiments comprising an operating handle 8; 108 as an actuation means, the operation of the operating handle 8; 108 is not limited to that of the illustrated embodiments. Rather, the operating handle 8; 108 may be moved directly between its first position and its second position, i.e. without the need to move the handle to an intermediary position first. In such embodiments, the handle may be moved between its first position and its second position by rotation about a fixed point or axis, or may be moved linearly between the positions.

The above embodiment is described by way of example only. Many variations are possible without departing from the scope of the invention as defined in the appended claims.

1. A waste receptacle comprising a container having a means to connect a refuse bag within the container for holding waste items and a compaction mechanism, the compaction mechanism comprising at least one compactor plate, moveable between a non-compacting position and a compacting position;
wherein the at least one compactor plate is operable in use to move at least a portion of a connected refuse bag over waste items located within the refuse bag when moving from its non-compacting position to its compacting position and subsequently directly act upon an outer surface of the connected refuse bag to compact the waste items located therein.

2. A waste receptacle of claim 1 wherein the at least one compactor plate is rotatable between its non-compacting position and its compacting position.

3. A waste receptacle of claim 2 wherein the or each compactor plate is located parallel and adjacent to a side wall of the container in its non-compacting position and is rotatable to its compacting position in which it is located perpendicular to said side wall of the container.

4. A waste receptacle of claim 1 wherein the at least one compactor plate is linearly moveable between its non-compacting position and its compacting position.

5. A waste receptacle of claim 4 wherein the or each compactor plate is located perpendicular and adjacent to a side wall of the container is its non-compacting position in a position where it is not positioned directly above a connected refuse bag within the container, and is moveable horizontally to a position in which it is located directly above the connected refuse bag remaining perpendicular to the side wall of the container.

6. A waste receptacle of claim 1 wherein the at least one portion of a connected refuse bag moved over the waste items under operation of the or each compactor plate comprises a portion defining an open end of the refuse bag such that the open end of the refuse bag is at least partially closed when the or each compactor plate moves from its non-compacting position to its compacting position.

7. A waste receptacle according to claim 1 wherein the or each compactor plate may only partially close a connected refuse bag when moving from its non-compacting position to its compacting position such that there is provided an air flow into and out of the refuse bag.

8. A waste receptacle as claimed in claim 7 wherein there is provided more than one compactor plate, and there is at least one gap between each compactor plate when in their compacting positions to provide said air flow.

9. A waste receptacle as claimed in claim 1 wherein the at least one compactor plate is moveable between its non-compacting position and its compacting position under the operation of an actuation means.

10. A waste receptacle as claimed in claim 9 wherein the actuation means comprises an operating handle, moveable between a first position and a second position.

11. A waste receptacle as claimed in claim 10 wherein the operating handle is moveable between its first position and its second position through linear movement of the operating handle, or through rotation of the operating handle about a fixed axis.

12. A waste receptacle as claimed in claim 10 wherein the operating handle is moveable between its first position and its second position via an intermediary position.

13. A waste receptacle as claimed in claim 12 wherein the operating handle is rotatable between its first position and the intermediary position and is linearly moveable between the intermediary position and its second position.

14. A waste receptacle comprising a container having a refuse bag located therein for holding waste items and a compaction mechanism, the compaction mechanism comprising at least one compactor plate, moveable between a non-compacting position and a compacting position; wherein the at least one compactor plate is operable to move at least a portion of a refuse bag over waste items located within the refuse bag when moving from its non-compacting position to its compacting position and subsequently directly act upon an outer surface of the refuse bag to compact the waste items located therein.

15. A method of compacting waste items located in a refuse bag within the waste receptacle of claim 1, the method comprising the steps of:
a. connecting a refuse bag within the container;
b. moving the at least one compactor plate from its non-compacting positon to its compacting position;
c. moving at least a portion of the refuse bag over waste items located therein to at least partially close the refuse bag; and
d. moving the at least one compactor plate when in its compacting position in a direction to act upon an outer surface of the refuse bag to compact the waste items.

16. A method as claimed in claim 15 wherein the portion of the refuse bag which is moved over the waste items is moved automatically upon the movement of the at least one compactor plate from its non-compacting position to its compacting position.

17. A method as claimed in claim 15 wherein the at least one compactor plate is rotated or is moved linearly from its non-compacting position to its compacting position.

18. A method as claimed claim 15 wherein the at least one compactor plate is moved from its non-compacting position to its compacting position, and subsequently moved to compact said waste items under the operation of an actuation means.

19. A method as claimed in claim 18 wherein the actuation means comprises an operating handle.
